(19) United States
(12) Patent Application Publication
(10) Pub. No.: US 2008/0201960 A1
(43) Pub. Date: Aug. 28, 2008

(54) ROTARY CUTTER KNIFE WITH DIVIDED GUARD MEMBERS

(75) Inventor: Toshiyuki WATANABE, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: OLFA CORPORATION, Osaka-shi (JP)

(21) Appl. No.: 12/035,332

(22) Filed: Feb. 21, 2008

(30) Foreign Application Priority Data
Feb. 22, 2007 (JP) 2007-42393

(51) Int. Cl. B26B 29/02; B26B 1/00; B26B 25/00; B26B 1/10

(52) U.S. Cl. 30/151

(57) ABSTRACT

A rotary cutter knife provided with a guard member, which extends beyond the outer edge of the rotary blade to enhance the safety. The guard member is divided into two sub-members, which can independently move between an extended position where an outer profile of the sub-member extends beyond an outer edge of the rotary blade and a retracted position where the outer profile of the sub-member is retracted such that the outer edge of the rotary blade is exposed. Thus, the cutting edge of the rotary blade is not exposed in the area where the cutting operation is not performed, and the cutting edge is exposed only in a limited area associated with the cutting operation, such that the highly enhanced safety is realized.

### BACKGROUND OF THE INVENTION

1. Field of the Invention

The present invention relates to a rotary cutter knife having a rotary blade, and in particular, to a rotary cutter knife provided with a guard member, which extends beyond the outer edge of the rotary blade to enhance the safety.

2. Description of the Related Art

In the fields of rotary cutter knives which cut for example the cloth with a rotary blade, there have been known a type of safety cutter knife, which is provided with a guard member intended for enhance of the safety when out of use. FIG. 1 shows such the safety type of a cutter knife, which was disclosed in Japanese Design Gazette No. 1090663.

In FIG. 1(a), the guard member 80 is retracted toward the cutter knife body 60, such that the outer edge 71 of the rotary blade 70 is exposed. In this situation, a user holds the grip (cutter knife body) 60 and can cut for example a cloth.

FIG. 1(b) shows another situation where the cutter knife is out of use. That is, the guard member 80 is extended beyond the outer edge 71 of the rotary blade 70, such that the cutter knife is made out of operation to enhance the safety.

### SUMMARY OF THE INVENTION

An object of the present invention is to further enhance the safety in the cutter knife, provided with the guard member like the above.

In order to achieve the objects of the present invention, there is provided a cutter knife comprising: a rotary blade, which is held on a body of the cutter knife; and a guard member held on the body of the cutter knife, the guard member being able to slide between an extended position where an outer profile of the guard member extends beyond an outer edge of the rotary blade and a retracted position where the outer profile of the guard member is retracted such that the outer edge of the rotary blade is exposed; characterized in that the guard member is divided into two sub-members, which can independently slide between the extended position and the retracted position.

With the cutter knife of the present invention constructed as above, the cutting edge of the rotary blade is not exposed in the area where the cutting operation is not performed, and the cutting edge is exposed only in a limited area associated with the cutting operation, because only one of the guard members (one sub-member) can be retracted, while the other is extended. Thus, the safety can be highly enhanced.

### BRIEF DESCRIPTION OF THE DRAWINGS

These and other objects and features of the present invention will become apparent from the following description taken in conjunction with the preferred embodiments thereof with reference to the accompanying drawings.

FIG. 1 is an explanatory view of a conventional cutter knife.

FIG. 2 is a front view of an embodiment of the cutter knife according to the present invention.

FIG. 3 is a front view of the cutter knife in FIG. 2, wherein only the upper guard member is extended.

FIG. 4 is a front view of the cutter knife in FIG. 2, wherein only the lower guard member is extended.

FIG. 5 shows the practical use of the cutter knife in the condition shown in FIG. 3.

FIG. 6 shows the practical use of the cutter knife in the condition shown in FIG. 4.

### DETAILED DESCRIPTION OF THE PREFERRED EMBODIMENT

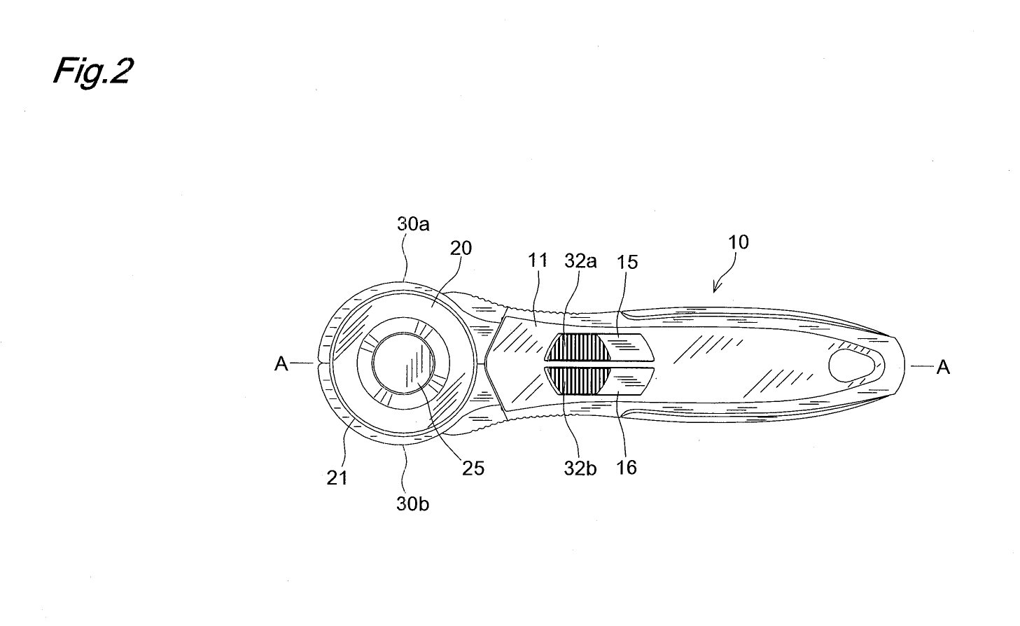

Referring to FIGS. 2 to 6, a description is made below on the cutter knife, according to an embodiment of the present invention.

FIG. 2 is a front view of an embodiment of the cutter knife 10 according to the present invention. The cutter knife 10 includes an elongated body 11 serving as a grip, at one end of which a rotary blade 20 is held. The rotary blade 20 can rotate around the post 25.

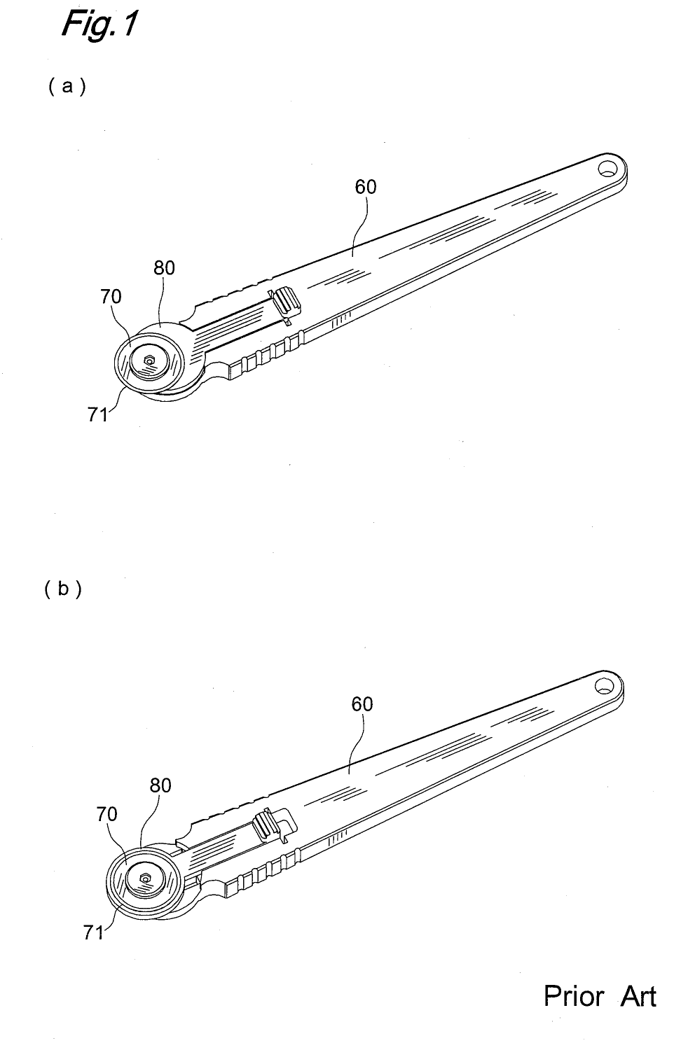

The cutter knife 10 is provided with two guard members 30a and 30b (sub-members), which can be independently operated. These two guard members 30a, 30b are so formed like a manner in that the guard member 80 of the conventional cutter knife in FIG. 1 is divided into two sub-members.

The guard members 30a, 30b are independently divided ones, each of which can move between an extended position and a retracted position, with an operation of slider knobs 32a, 32b. The slider knobs 32a, 32b are exposed outside through the openings 15, 16, which are formed on the cutter knife body 11.

### <<Situation Where the Upper Guard Member is Only Extended>>

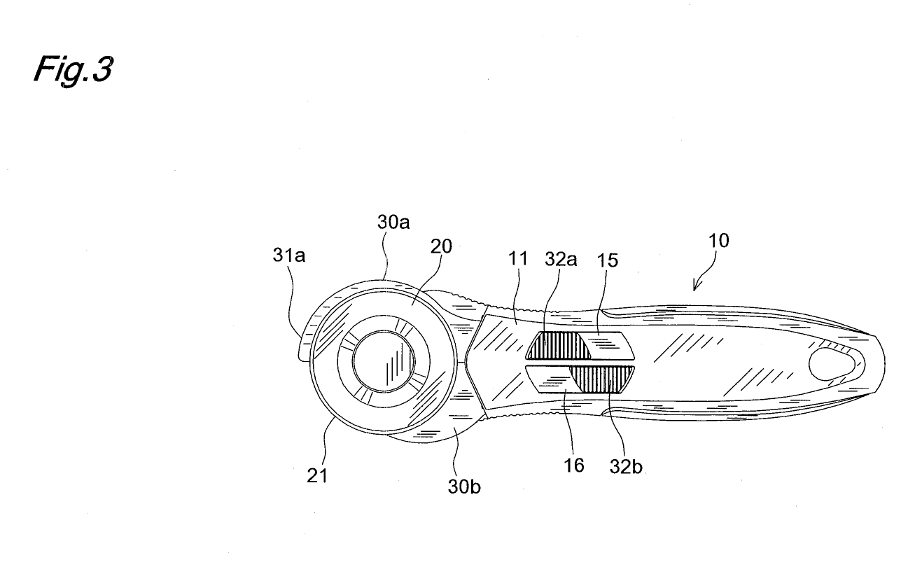

In FIG. 3, only the upper guard member 30a in drawing is extended. In this extended position, the outer profile 31a of the guard member 30a extends beyond the outer edge 21 of the rotary blade 20. That is, only the edge portion, which is exposed in the lower area in FIG. 3, can perform the cutting operation.

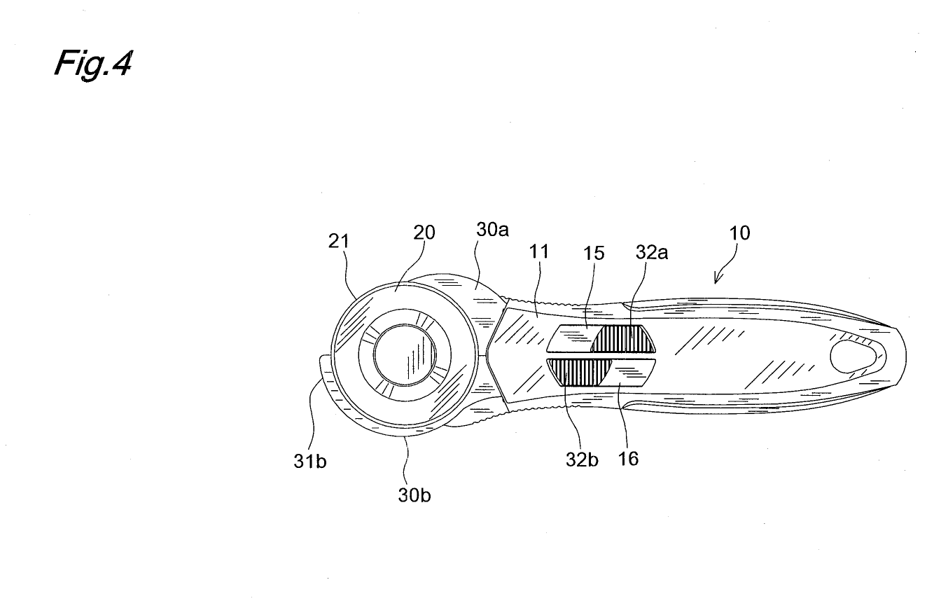

In FIG. 3, the lower guard member 30b in drawing is retracted into the cutter knife body 11. In this retracted position, the outer profile 31b (see, FIG. 4) of the guard member 30b is retracted, such that the outer edge 21 of the rotary blade 20 is exposed.

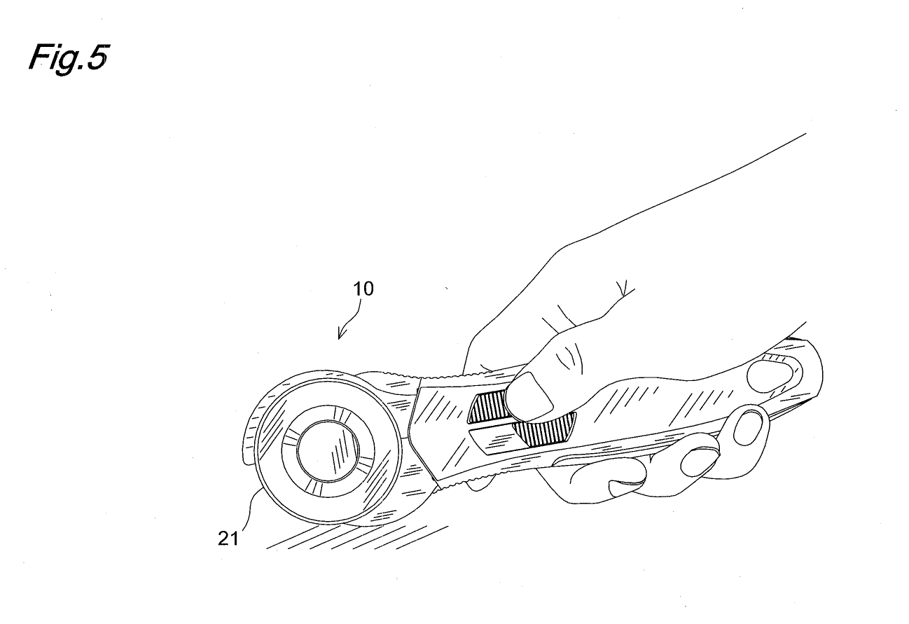

In this condition, as shown in FIG. 5, a user can grip the cutter knife 10 in right hand to perform the cutting operation. As can be seen in FIG. 5, the cutting edge 21 is exposed to the outside, only in a limited area adjacent to the object to be cut (for example, a cloth). In the upper area, where the edge 21 does not perform the cutting operation, the edge 21 is guarded.

Contrary to this, in the conventional cutter knife in FIG. 1, the cutting edge is to be exposed also in the upper area, where the edge 21 does not perform the cutting operation. In the cutter knife of the present invention, in the area where the cutting operation may not be performed, the cutting edge of the rotary blade is not made exposed, in order to further enhance the safety.

### <<Situation Where the Lower Guard Member is Only Extended>>

In FIG. 4, contrary to FIG. 3, only the lower guard member 30b is extended, and the upper guard member 30a is retracted. That is, the outer profile 31b of the lower guard member 30b extends beyond the outer edge 21 of the rotary blade 20, and the outer profile 31a (see FIG. 3) of the upper guard member 30a is retracted to expose the outer edge 21 of the rotary blade 20.

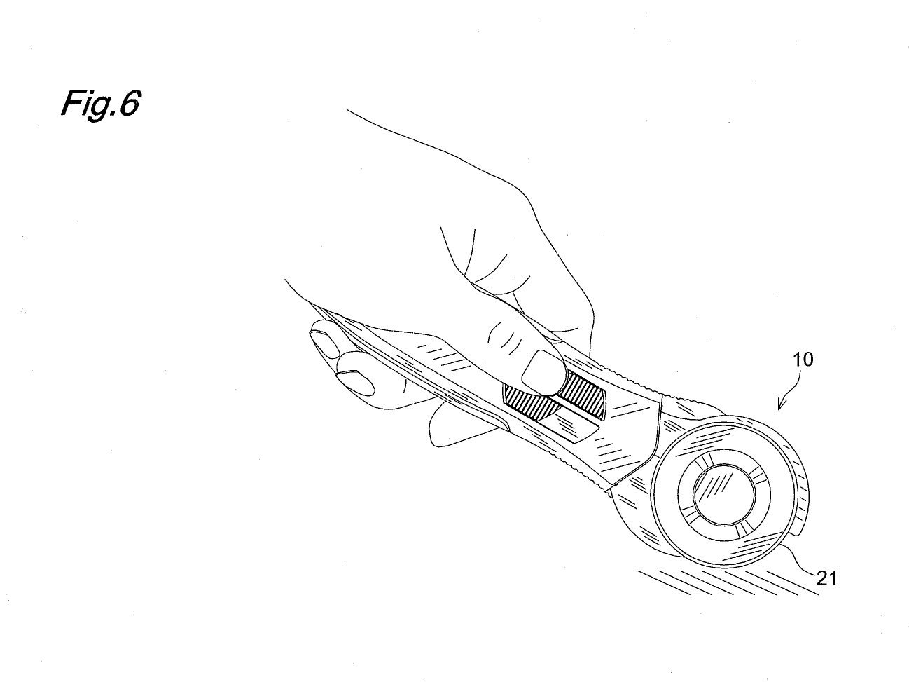

In this condition, as shown in FIG. 6, a user can grip the cutter knife 10 in left hand to perform the cutting operation. Also in this case, like as above mentioned, the safety can be enhanced, because the cutting edge of the rotary blade is not made exposed in the area where the cutting operation may not be performed.

### <<Situation Where the Cutter Knife is Not Used>>

When a user does not use the cutter knife, both of the guard members 30a, 30b are extended, as shown in FIG. 2. It is preferable that the guard members 30a, 30b can be temporary fixed at the extended position and the retracted position, with a well known mechanism, for example an elastic fitting.

In the shown embodiment, two guard members 30a, 30b are divided along the line “A” in FIG. 2. This dividing line “A” passes a center of the rotary blade 20, and extends along the extended position and the retracted position. But, it is to be noted that any suitable direction of the dividing line can be employed in the present invention, other than what is shown.

Although the present invention has been fully described in connection with the preferred embodiment thereof with reference to the accompanying drawings, it is to be noted that various changes and modifications are apparent to those skilled in the art. Such changes and modifications are to be understood as included within the scope of the present invention as defined by the appended claims unless they depart therefrom.

What is claimed is:

1. A cutter knife comprising:
a rotary blade, which is held on a body of the cutter knife; and
a guard member held on the body of the cutter knife, the guard member being able to slide between an extended position where an outer profile of the guard member extends beyond an outer edge of the rotary blade and a retracted position where the outer profile of the guard member is retracted such that the outer edge of the rotary blade is exposed; characterized in that:
the guard member is divided into two sub-members, which can independently slide between the extended position and the retracted position.

2. The cutter knife according to claim 1, characterized in that:
the guard member is divided into the two sub-members, along a line which passes a center of the rotary blade and extends along the extended position and the retracted position.
